(19) United States
(12) Patent Application Publication
(10) Pub. No.: US 2025/0024223 A1
(43) Pub. Date: Jan. 16, 2025

(54) SYSTEM AND METHOD FOR SECURELY PROVIDING LOCATION INFORMATION OF ELECTRONIC DEVICE

(71) Applicant: Restrata Solutions Limited, Aberdeen (GB)

(72) Inventors: Botan Osman, Aberdeen (GB); Jason Atlas, Oxford (GB); Hiran Gunaratne, Aberdeen (GB)

(73) Assignee: Restrata Solutions Limited, Aberdeen, SC (GB)

(21) Appl. No.: 18/833,186

(22) PCT Filed: Jan. 27, 2023
(86) PCT No.: PCT/IB2023/050720

§ 371 Date: Jul. 25, 2024

(30) Foreign Application Priority Data
Jan. 27, 2022 (GB) 2201040.9

(51) Int. Cl. H04W 4/02; H04W 4/90

(52) U.S. Cl. CPC H04W 4/02; H04W 4/90

(57) ABSTRACT

Disclosed is a system for securely providing the location information of an electronic device. The system comprises a server arrangement communicatively coupled to the electronic device. The server arrangement is configured to: obtain location information and associated permissions pertaining to an electronic device, the location information being encrypted by the electronic device; determine access rights for the electronic device based on the permissions provided by the electronic device; receive a request from an entity to access the location information; determine whether the entity is authorized to access the location information; decrypt the location information of the electronic device if the entity is authorized to access the location information; and provide the decrypted location information to the entity.

### TECHNICAL FIELD

The teachings herein relate generally to secure localization systems and methods and more specifically, to a system and a method for securely providing location information of an electronic device.

### BACKGROUND

In recent times, increasing growth in technology has led to the rapid development of various services, such as telecommunication services, networking services, internet services, localization services and the like. Such services are being increasingly utilized by millions of users worldwide, such as by customers and/or subscribers employing such services. Further, with the advent of electronic and/or mobile devices such as, laptops, personal cell phones, smartwatches, and the like associated with a user, determining location information of the user has become relatively easier. By using communication networks such as internet services, the location information of the user may be sent to an enterprise or another individual that is remote to the user.

The location information is extremely valuable and private. Hence, easy access of the location information by anyone apart from the user may lead to an invasion of privacy. Often, the accessed location information may be used for illegal and unauthorized purposes, that may eventually put the user at risk. However, organizations, such as, national governments, employers, health care departments, and the like may need to track certain individuals. For example, the employer may wish to track the location of the employee. In such cases, organizations may employ conventional techniques to track the individual. However, the biggest hurdle to this is maintaining privacy and a general lack of trust between the individual being tracked and the person/organization tracking the individual. Moreover, there are not many legitimate use cases for the person to be tracked throughout the day, month, year, or even lifetime. This may often result in the individual not being willing to be tracked. Therefore, in light of the foregoing discussion, there exists a need to overcome the aforementioned drawbacks associated with the conventional techniques of tracking individuals.

### SUMMARY

The teachings herein seek to provide a system and a method for securely providing location information of an electronic device. The teachings herein seeks to provide a solution to the existing problem of a general lack of trust between an individual being tracked and a person tracking the individual. An aim of the teachings herein is to provide a solution that overcomes at least partially the problems encountered in prior art and provides an improved system and method for securely providing location information of the electronic device.

The object of the teachings herein is achieved by the solutions provided in the enclosed independent claims. Advantageous implementations of the teachings herein are further defined in the dependent claims.

In one aspect, the teachings herein provide a system for securely providing location information of an electronic device, the system comprising a server arrangement communicatively coupled to the electronic device, wherein the server arrangement is configured to:
obtain location information and associated permissions pertaining to an electronic device, the location information being encrypted by the electronic device;
determine access rights for the electronic device based on the permissions provided by the electronic device, wherein the access rights comprise one or more conditions for sharing location information;
receive a request from an entity to access the location information of the electronic device;
determine whether the entity is authorized to access the location information of the electronic device based on the determined access rights associated with the electronic device;
decrypt the location information of the electronic device if the entity is authorized to access the location information based on the determined access rights; and
provide the decrypted location information to the entity.

In another aspect, the teachings herein provide a method for securely providing location information of an electronic device, wherein the method comprises:
obtaining location information and associated permissions pertaining to the electronic device, the location information being encrypted by the electronic device;
determining access rights for the electronic device based on the permissions provided by the electronic device, wherein the access rights comprise one or more conditions for sharing location information;
receiving a request from an entity to access the location information of the electronic device;
determining whether the entity is authorized to access the location information of the electronic device based on the determined access rights associated with the electronic device;
decrypting the location information of the electronic device if the entity is authorized to access the location information; and
providing the decrypted location information to the entity.

It has to be noted that all devices, elements, circuitry, units and means described in the teachings herein could be implemented in the software or hardware elements or any kind of combination thereof. All steps which are performed by the various entities described in the teachings herein as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity that performs that specific step or functionality, it should be clear for a skilled person that these methods and functionalities can be implemented in respective software or hardware elements, or any kind of combination thereof. It will be appreciated that features of the teachings herein are 30 susceptible to being combined in various combinations without departing from the scope of the teachings herein as defined by the appended claims.

Additional aspects, advantages, features and objects of the teachings herein would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the teachings herein, exemplary constructions of the disclosure are shown in the drawings. However, the teachings herein are not limited to specific methods and instrumentalities disclosed herein. Moreover, those in the art will understand that the drawings are not to scale. Wherever possible, like elements have been indicated by identical numbers.

Embodiments of the teachings herein will now be described, by way of example only, with reference to the following diagrams wherein:

FIG. 1 is a block diagram of a system for securely providing location information of an electronic device, in accordance with an embodiment of the teachings herein;

FIG. 2 is a schematic diagram of a process flow for securely providing location information of the electronic device, in accordance with an embodiment of the teachings herein; and

FIG. 3 is a flowchart of a method for securely providing location information of the electronic device, in accordance with an embodiment of the teachings herein.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the teachings herein and ways in which they can be implemented. Although some modes of carrying out the teachings herein have been disclosed, those skilled in the art would recognize that other embodiments for carrying out or practicing the teachings herein are also possible.

In one aspect, the teachings herein provide a system for securely providing location information of an electronic device, the system comprising a server arrangement communicatively coupled to the electronic device, wherein the server arrangement is configured to:
obtain location information and associated permissions pertaining to an electronic device, the location information being encrypted by the electronic device; determine access rights for the electronic device based on the permissions provided by the electronic device, wherein the access rights comprise one or more conditions for sharing location information;
receive a request from an entity to access the location information of the electronic device;
determine whether the entity is authorized to access the location information of the electronic device based on the determined access rights associated with the electronic device;
decrypt the location information of the electronic device if the entity is authorized to access the location information based on the determined access rights, and provide the decrypted location information to the entity.

In another aspect, the teachings herein provide a method for securely providing location information of an electronic device, wherein the method comprises:
obtaining location information and associated permissions pertaining to the electronic device, the location information being encrypted by the electronic device;
determining access rights for the electronic device based on the permissions provided by the electronic device, wherein the access rights comprise one or more conditions for sharing location information;
receiving a request from an entity to access the location information of the electronic device;
determining whether the entity is authorized to access the location information of the electronic device based on the determined access rights associated with the electronic device;
decrypting the location information of the electronic device if the entity is authorized to access the location information; and
providing the decrypted location information to the entity.

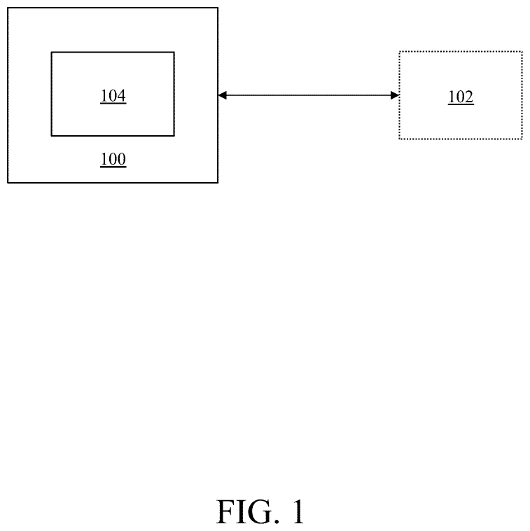

FIG. 1 is a block diagram of a system 100 for securely providing location information of an electronic device 102, in accordance with an embodiment of the teachings herein. As shown, the system 100 comprises a server arrangement 104, wherein the server arrangement is communicatively coupled to the electronic device 102.

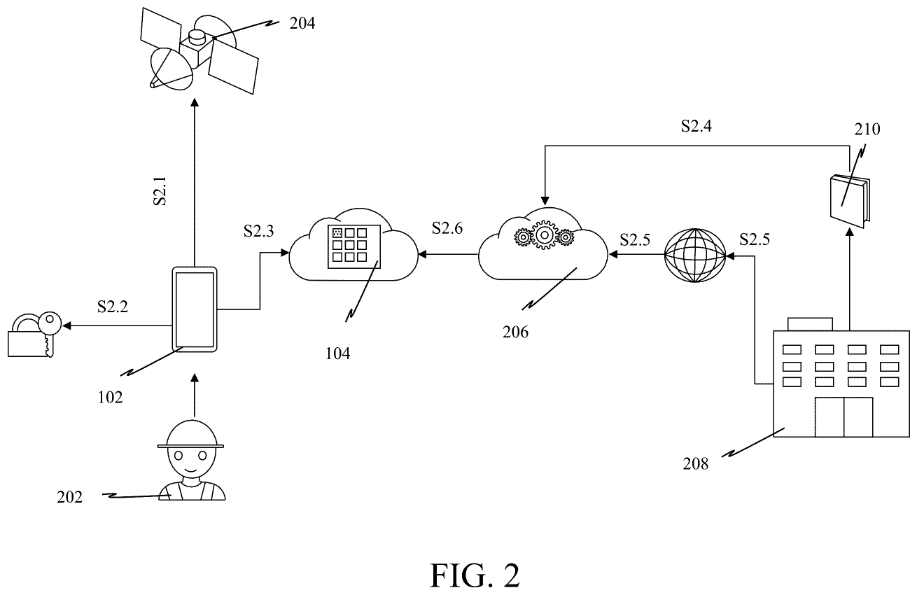

FIG. 2 is a schematic diagram of a process flow for securely providing location information of the electronic device 102, in accordance with an embodiment of the teachings herein. The process flow includes steps S2.1 to S2.6, which have been described in detail in the proceeding paragraphs.

Referring to FIGS. 1 and 2 in combination, the server arrangement 104 may be a company cloud, a cloud, an open internet, a private routing to a closed data centre, and the like that may house an individual user private data store of businesses. The term “server arrangement” refers to a structure and/or module that includes programmable and/or non-programmable components configured to store, process and/or share information to enable the system 100 to securely provide location information of the electronic device 102. Optionally, the server arrangement 104 includes any arrangement of physical or virtual computational entities capable of enhancing information to perform various computational tasks. Furthermore, it will be appreciated that the server arrangement 104 may be implemented as a hardware server and/or a plurality of hardware servers operating in a parallel or in a distributed architecture. In an example, the server arrangement 104 may include components such as a memory, a processor, a data communication interface, a network adapter, and the like, to store, process and/or share information with other computing devices, such as the electronic device 102.

The electronic device 102 may be a device carried by a user whose location may need to be accessed. In some embodiments, the electronic device is one of: a user device, an industrial asset, an IoT device, and an autonomous vehicle. Herein, the industrial asset may be a resource that is related to an industry whose location needs to be accessed. The IoT device or the Internet of Things device may include sensors, actuators, and the like that may interact with each other via the Internet. The autonomous vehicle also known as a robot car, a self-driving car may sense an environment and may navigate through the environment with minimum human input. The electronic device 102 of the teachings herein may be, such as cellular phones, smartphones, personal digital assistants (PDAs), handheld devices, laptop computers, personal computers, tablet computers, desktop computers, virtual reality (VR) or extended reality (XR) headsets, VR or XR glasses, smart televisions, a server, and the like, that are operable to transmit location information and may be carried by the user whose location may need to be accessed. Herein, the user may be any individual that a contract holder such as an employer, business or organization wishes to track.

Referring to FIG. 2, the electronic device 102 is the personal cell phone carried by a user 202. Referring back to FIGS. 1 and 2 in combination, the server arrangement 104 may be communicatively coupled to the electronic device 102.

The server arrangement 104 is configured to obtain location information and associated permissions pertaining to the electronic device 102, the location information being encrypted by the electronic device 102. At step S2.1, the electronic device 102 may determine its own location by decoding signals received from a satellite 204. The satellite 204 is a representation of a remote location service (RTLS) delivery mechanism. The electronic device 102 may directly subscribe to the satellite 204, a third-party data feed, or any other type of edge or device delivery. The technique of determining the location may not matter. The satellite 204 may be simply a means of bringing real-time tracking and location data from outside the personal cell phone 102 into the personal cell phone 102 via internet services. In some embodiments, a part of a software package from the business may be installed on the electronic device 102. The software package may be a means to track the user 202 via the electronic device 102. The software package may include an encryption library and an application programming interface (API) that calls out to the satellite 204 for determining the location of the electronic device 102. The satellite 204 sends location details over the API back to the electronic device 102. At step S2.2, the electronic device 102, on ingestion, encrypts location information using an encryption service and then may send the encrypted location information to the server arrangement 104. The encryption service on the electronic device 102 may encapsulate the location information into a crypto string. The location information may be encrypted using secure key/store key encryption which may represent a mechanism used to encrypt the location information received from the satellite 204. Some examples of secure key/store key encryption may be a public/private key encryption, wallet/ledger (blockchain) encryption, and the like.

Optionally, the electronic device 102 is configured to encrypt and the server arrangement 104 is configured to decrypt the location information using a public key and private key pair. It will be appreciated that the public key may be shared with everyone in the system 100. Each public key has a private key. By using the public key, a message may be encrypted and correspondingly by using the private key the encrypted message may be decrypted. Herein, the electronic device 102 may know the public key of an entity 208 that wishes to access the location information. The electronic device 102 may encrypt its own location information using the public key. The server arrangement 104 may decrypt the encrypted location information using the private key. Apart from the location information, the server arrangement 104 may also obtain the associated permissions pertaining to the electronic device 102. Thus, the server arrangement 104 may have the ability to unlock the location information owned by the user 202 only when the user 202 permits to do so. A company attempting to track and locate the user 202 cannot do so unless they are expressly given permissions.

It may be noted that the permissions including conditions, a time to live (TTL) for a communication session and an ability to rescind access to the location information is entirely owned by the user 202. It will be appreciated that the system 100 does not interfere with regulatory aspects of data ownership i.e., associated with the location information and is dependent upon the arrangements of the implementation. Thus, the user 202, via the process outlined above, may have the encryption service on their personal cell phone 102 as part of a tracking application being installed. This encryption service must be independently audited for confirming that all current legal guidelines for encryption and access standards are followed. The encryption service may, via a mechanism chosen by an implementor, for example, using a SHA1024 private key or leveraging a blockchain wallet, encrypt the location information. This will mean only the entity 208 in question may now unlock and access the location information.

In some embodiments, the server arrangement 104 may include the individual user private data store that may be a dedicated data store on a per user basis. Herein, each individual store may be encrypted with secure key/store key encryption that is issued and owned by an individual employee, such as the user 202. An encryption level of each individual user's private data store may be set to any level that the software platform chooses to implement. The encryption service may not be relevant for setting the encryption level of the individual user's private data store. Referring to FIG. 2, at step S2.3, the location information is stored in the individual user private data store of the server arrangement 104.

It may be further noted that, in some embodiments, an employee's share key host may be at least one of a cloud, data centre, enterprise, and the like. In fact, it is worth noting that all environments may be on a same physical machine, co-located, or distributed around the world. As all services are connected via API, location is irrelevant. An employee's share key host may provide a session key. The employee's share key host may use public key infrastructure (PKI) shared delegation services issued from private key ownership; blockchain delegator wallet, or trust wallet implementation. Herein, the actual encryption methodology may not be relevant, and wherein the aspect of data ownership and process flow are integral to the teachings herein.

Referring to FIG. 1 and FIG. 2 in combination, the server arrangement 104 is further configured to determine access rights for the electronic device 102 based on the permissions provided by the electronic device 102. Herein the access rights comprise one or more conditions for sharing location information. The one or more conditions may be one or more rules that may help in deciding whether the entity 208 is permitted to access the location information of the electronic device 102 or not.

Optionally, the electronic device 102 is associated with an employee and the entity 208 is an employer. Referring to FIG. 2, the electronic device 102 is carried by the employee, such as, the user 202 and the entity 208 is the employer.

Optionally, the server arrangement 104 is configured to determine the access rights based on a contractual agreement between the employer and the employee. Referring to FIG. 2, at step S2.4, a broker 206 which is a privacy location safe service is provided with a contractual agreement 210 between the user 202 and the entity 208. Herein, the broker 206 may be a public cloud or simply a representation of where the software platform of the business may run. It will be appreciated that the contractual agreement 210 may be a contract consisting of terms and conditions of what to do and/or what not to do that is signed between two parties such as, the employer and the employee. In some cases, the contractual agreement 210 may allow the employer to access the location information of the employee. In other words, the contractual agreement 210 between the employer and the employee may include how, when and under what circumstances the employer is able to view and track the employee's location information. That is, the contractual agreement 210 may state reasons as to why the location information may be provided. Thus, the server arrangement 104 may refer to the contractual agreement 210 to determine the access rights. The set of access rights may either allow or refrain the employer from accessing the location information of the employee. For example, the set of access rights may allow the server arrangement 108 to send a list of people present within a given latitudes and longitudes. It will be appreciated that the contractual agreement 210 is not limited to employee-employer relationships and may include an agreement existing between any two or more users, subscribers, businesses or organizations.

Optionally, the server arrangement 104 is configured to determine the access rights based on the time of services provided by the employee 202, location of services of the employee 202, and duration of services provided by the employee 202 as agreed in the contractual agreement 210. The employee 202 may not want the location information to be accessible by the employer 208 throughout the day. Hence, certain situations and conditions may be signed in the contractual agreement 210 according to which the location information of the employee 202 may be accessed by the employer 208. The time of services provided by the employee 202 may be the time duration in which the employee 202 works. The time of services may be timing such as, weekday, weekend, and time of day. The location of services of the employee 202 may be the location at which the employee 202 may work. For example, the location of services may determine whether the employee 202 is working inside the office or outside the office. The duration of services may be time span in which the employee 202 may provide services to the employer 208. The access right may be based on the time of services provided by the employee 202, the location of services of the employee 202, and the duration of services provided by the employee 202. For example, if the employee 202 has working hours from 9 am to 5 μm, the access right may allow location information to be accessed by the employer 208 only during working hours. Similarly, the access right may allow the employer 208 to access location information of the employee 202, if the employee 202 moves from a location A to a location B, or to a place where some event is taking place to which they have subscribed to. In another example, if all employees 202 that have said in their contract agreement that they were business travellers, and their location is detected in a place outside of the scope of their travel boundaries, the access rights may grant permission to the employer 208 to access the location information of the employee 202. It may be noted that system 100 does not have to be an employee/employer relationship and may work just we well if this is done via a consumer application, and terms and conditions of the consumer application articulate privacy and location conditions.

Optionally, the server arrangement 104 is configured to determine the access rights based on a state of an application installed in the electronic device 102, wherein the state of the application is one of: an active state and an inactive state. Herein, the application may be a part of the software platform installed on the electronic device 102. The software platform may be a core business software platform that may deliver tracking and location capabilities and may be operated in a data centre. It will be appreciated that the location information may be an agnostic location and thus beneficially provides flexibility to the system 100 and the user thereof. The application may be in the active state or the inactive state. The application may be in the active state if it is being used by the user 202 and in the inactive state if it is not being used by the user 202. The server arrangement 104 may determine the access rights based on the state of an application. If the application is in the active state, the location information of the electronic device 102 may be accessed and if the application is in the inactive state, the location information of the electronic device 102 may not be accessed. However, in cases of emergencies, the access to the location information may be granted even when the application is in the inactive state. The server arrangement 104 may also determine the access rights based on a state of the electronic device 102 that gives an idea of the state of the user 202 such as, whether the user 202 is working, not working, logged in or not logged in.

Optionally, the server arrangement 104 is configured to determine the access rights based on emergency conditions in a geographical area of the electronic device 102, and wherein the emergency condition is one or more of: a natural calamity, an accident, an unauthorized access of the electronic device 102, and presence of the electronic device 102 in a restricted geographical area. Herein, the natural calamity may be an earthquake, a hurricane, a volcanic eruption, and the like. It may be noted that the emergency condition may be external events of urgency connected to a location and the server arrangement 104 may allow tracking if the user 202 is in that location. In cases of emergency conditions, the access to the location information may be granted even when the application is in an inactive state. For example, if a hurricane is coming and the entity 208 needs to evacuate its employee, such as the user 202, then the entity 208 may track and provide emergency services to the user 202 even when the application is in the inactive state as the user 202 may not have the time to “opt in” in order to change the state of the application to the active state. Similarly, if the user 202 carrying the electronic device 102 meets accident, the entity 208 may be provided access to the location information. Also, if an unauthorized person accesses the electronic device 102, the location information of the electronic device 102 may be provided to the entity 208. Furthermore, if the user 202 carrying the electronic device 102 enters the restricted geographical area, the entity 208 may be provided access to the location information. The server arrangement 104 may also allow tracking of the location information according to alert levels, for example, if high alert is present in the location, the tracking may be allowed.

Optionally, the server arrangement 104 is configured to determine the access rights based on a health condition of an individual associated with the electronic device 102. The health condition may define the health of the individual. The health condition may be divided into categories such as, normal, severe, and the like. The health condition may be obtained by determining a number of parameters, such as heart rate, blood pressure, eye health, and the like of the individual. In other words, the health condition may be physical conditions such as, heart rate, or other health vitals, that could also be applied to determine the set of access rights. If the individual is ill, the tracking of the individual may be allowed.

Optionally, the server arrangement 104 is configured to provide the health condition of the individual to the entity 208. Herein, the entity 208 is at least one of: a health organization, a designated health specialist, and emergency contacts of the individual. According to the health of the individual, the access rights may grant access to the location information of the electronic device 102 to the entity 208. For example, if heart rate is more than a hundred beats per minute, the access rights may grant access to the location information of the electronic device 102. The health condition of the individual may be also provided so that the entity 208, may take actions, such as, sending a medical aid to the individual according to the health condition. Thus, apart from data related to only the location of the individual, the location information and the health condition such as, health data of vitals may be also provided.

The server arrangement 104 is configured to receive a request from the entity 208 to access the location information of the electronic device 102. Herein, the entity 208 may be a body and/or a person that needs to access the location information of the electronic device 102. Optionally, the entity 208 is one of: an organization, a law enforcement agency, a health department, a government regulatory body, and an individual. The system 100 may be also used for consumers apart from individual use cases.

Optionally, the server arrangement 104, the electronic device 102, and the entity 208 are communicating over a blockchain network. The blockchain network may ensure that the location information of the electronic device 102 may not be altered or hacked. Each block in the block chain network may be time stamped, and cryptographically signed. Thus, even when a single block is hacked and altered by a hacker, the entity 208 and/or the server arrangement 104, may easily come to about the hacking. In order to corrupt the blockchain, the hacker may need to alter each block of the blockchain. For example, if few blocks of the request to access the location information of the electronic device 102 from the entity 208 is hacked, the server arrangement 104 may come to know about it and may deny the request straightaway.

The server arrangement 104 may provide disambiguation service itself by implementing the rules as it were. The server arrangement 104 may ingest a first data of the determined access rights from the business over a blind request. Herein, the first data may be: every individual user that is interested in being, every user permission vehicle to access data which may be in case of using something like the public/private key or shared key implementation and not necessarily the same for blockchain, and contract-based reasons as to why access may be granted. The blind request may be the request for accessing location information and tracking coordinates of the electronic device 102 made by the entity 208 through the software platform. The request may be a configurable poll (or auto) that may continuously make a request for all tracking and location information. The request may contain names of all employees, a mechanism for accessing the individual user private data store (for example, if a public key intrastate (PKI) mechanism is used, then it would be using the public or shared key) and conditions of request. Based on combination of the employee, public key, and condition such as, why the entity 208 wants location information a response may be generated with a yes/no outcome that may pertain to access granted or access denied respectively.

The server arrangement 104 is configured to determine whether the entity 208 is authorized to access the location information of the electronic device 102 based on the determined access rights associated with the electronic device 102. Herein, a decision of whether or not to grant access to the location is taken. That is, the server arrangement 104 may map request of accessing location information from each entity 208 against the determined access rights to allow access only if the conditions match. That is, according to the determined access rights associated with the electronic device 102, the location information may or may not be unlocked and accessible. For example, if the determined access rights allow access to location information from 9 am to 5 μm, and current time is 12 μm, the server arrangement 104 may determine that the entity 208 may be authorized to access the location information of the electronic device 102. Referring to the FIG. 2, at step S2.5, the entity 208 requests the broker 206 to access the location information of the electronic device 102. The broker 206 determines whether the entity 208 is authorized to access the location information of the electronic device 102 based on the determined access rights associated with the electronic device 102. At step S2.6 the broker 206 requests the server arrangement 104 to send the location information if the entity 208 is authorized to access the location information of the electronic device 102.

The server arrangement 104 is configured to decrypt the location information of the electronic device 102 if the entity 208 is authorized to access the location information based on the determined access rights. As discussed, the location information of the electronic device 102 is encrypted. In order to read the location information, the encrypted location information may be first decrypted using the secret key.

The server arrangement 104 is configured to provide the decrypted location information to the entity 208. The decrypted location information may be easily read by the entity 208. Thus, the server arrangement 104 may provide the location information of the electronic device 102 to the entity 208 according to the determined access rights.

Optionally, the server arrangement 104 is configured to deny access to the location information of the electronic device 102 if the entity 208 is not authorized to access the location information based on the determined access rights. In the above example, if the determined access rights allow access of location information from 9 am to 5 μm, and current time is 7 μm, the server arrangement 104 may deny access to the location information.

The teachings herein also provide a method for securely providing location information of an electronic device. The various embodiments and variants disclosed above apply mutatis mutandis to the present method without any limitations.

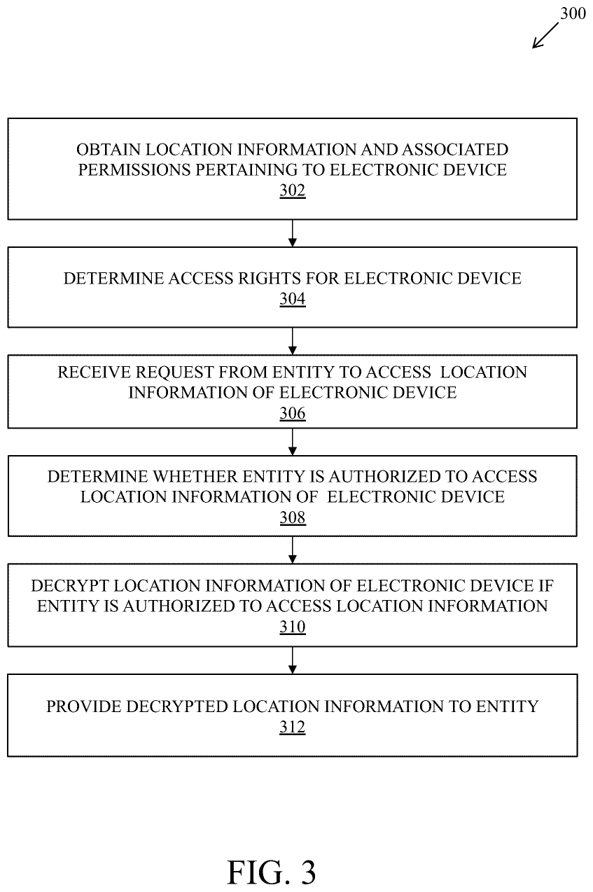

FIG. 3 is a flowchart of method 300 for securely providing location information of an electronic device, in accordance with an embodiment of the teachings herein. The method 300 includes steps 302 to 312, which have been described in detail in the proceeding paragraphs.

The method 300 includes at step 302, obtaining location information and associated permissions pertaining to the electronic device. Herein, the location information is encrypted by the electronic device. The method 300 includes at step 304, determining access rights for the electronic device based on the permissions provided by the electronic device. Herein, the access rights comprise one or more conditions for sharing location information. The method 300 includes at step 306, receiving a request from an entity to access the location information of the electronic device. The method 300 includes at step 308, determining whether the entity is authorized to access the location information of the electronic device based on the determined access rights associated with the electronic device. The method 300 includes at step 310, decrypting the location information of the electronic device if the entity is authorized to access the location information. The method 300 includes at step 312, providing the decrypted location information to the entity.

The teachings herein also provide a computer-program product having machine-readable instructions stored therein, which when executed by the server arrangement 104, cause the server arrangement 104 to perform the method 300.

In some embodiments, the system 100 may execute an application for securely providing location information of the electronic device 102, as described earlier in the teachings herein. In some implementations, the system 100 and/or application may be accessed via one or more of client applications. In some implementations, the system 100 may be a standalone application, or may be an applet/application/script/extension that may interact with and/or be executed within application or a component of the application and/or one or more of client applications. In some implementations, application may be a standalone application, or may be an applet/application/script/extension that may interact with and/or be executed within the system 100, a component of the system 100, and/or one or more of client applications. In some implementations, one or more of client applications may be a standalone application, or may be an applet/application/script/extension that may interact with and/or be executed within and/or be a component of the system 100 and/or application. Examples of client applications may include, but are not limited to, a standard and/or mobile web browser, an email application (e.g., an email client application), a textual and/or a graphical user interface, a customized web browser, a plugin, an Application Programming Interface (API), or a custom application. The instruction sets and subroutines of client applications which may be stored on storage devices coupled to electronic devices 102 may be executed by one or more processors and one or more memory architectures incorporated into the electronic devices 102.

In some embodiments, one or more of client applications may be configured to effectuate some or all of the functionality of the system 100 (and vice versa). Accordingly, in some implementations, the system 100 may be a purely server-side application, a purely client side application, or a hybrid server-side/client-side application that is cooperatively executed by one or more of client applications and/or the system 100.

In some embodiments, one or more of client applications may be configured to effectuate some or all of the functionality of application (and vice versa). Accordingly, in some implementations, application may be a purely server-side application, a purely client-side application, or a hybrid server-side/client-side application that is cooperatively executed by one or more of client applications and/or application. As one or more of client applications the system 100, and application taken singly or in any combination, may effectuate some or all of the same functionality, any description of effectuating such functionality via one or more of client applications the system, application or combination thereof, and any described interaction(s) between one or more of client applications, the system 100, application or combination thereof to effectuate such functionality, should be taken as an example only and not to limit the scope of the teachings herein.

The system 100 and the method 300 of the teachings herein in a nutshell provides a unique proposition that centres around an area of data ownership and flexible access parameters. The unique proposition fundamentally inverts the idea of data ownership concepts in a way that allows corporations and organisations that are providing the tracking service to meet all legitimate business interests they are trying to achieve, in a contract enforceable manner, while still giving the individual employee/consumer ownership and control. The entity of the teachings herein may create a programmatically implementable contractual agreement which may be an approved mechanism whereby via a document, web form or any other binding arrangement (depending on implementation) details of the rules depending on which the business can access the individual's location data for the purpose of tracking may be provided. The rules may range in nature and may be from very simple, structured rules, such as the business can access the location information while using the app, to stricter ones such as, the business can access location information during the working hours of 9 am to 5 μm. The rules may be also more combinatorial conditions. The system 100 and the method 300 may leave a number of aspects configurable or open to arbitration such as, how often the company keeps the location information available and accessible, if the user is to be alerted when they are being tracked or about the mechanisms to audit the location information.

The system 100 of the teachings herein may thus, provide privacy-safe location service which may be meant to handle broker dynamic rules. For example, if the entity 208 has drawn geofences for a project and the location information of anyone that moves into that geofence needs to be messaged. But, until they are in the drawn geofence, the entity 208 may not need the location information. The privacy-safe location service may be continuously polling the private data store. The privacy-safe location service may include a simple deterministic rules engine or a more dynamic machine learning non-deterministic engine or anything in between. For a consumer application, the privacy-safe location service may be moving into hot regions for a game, completing a series of game tasks that unlock a location-specific reward, treasure hunt, taxi service, or anything the imagination and engineers can think of and build. In an exemplary scenario, such as in case of a natural calamity like a hurricane, the system 100 is configured to alert users in a wide area i.e., all the users within a geofence of a 10-mile or a 100-mile radius are notified or alerted about the natural calamity.

Modifications to embodiments of the teachings herein described in the foregoing are possible without departing from the scope of the teachings herein as defined by the accompanying claims. Expressions such as “including”, “comprising”, “incorporating”, “have”, “is” used to describe and claim the teachings herein are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the teachings herein, which are, for clarity, described in the context of separate embodiments, may also be provided in combination in a single embodiment. Conversely, various features of the teachings herein, which are, for brevity, described in the context of a single embodiment, may also be provided separately or in any suitable combination or as suitable in any other described embodiment of the disclosure.

1. A system for securely providing location information of an electronic device, the system comprising a server arrangement communicatively coupled to the electronic device, wherein the server arrangement is configured to:
obtain location information and associated permissions pertaining to an electronic device, the location information being encrypted by the electronic device; determine access rights for the electronic device based on the permissions provided by the electronic device, wherein the access rights comprise one or more conditions for sharing location information;
receive a request from an entity to access the location information of the electronic device;
determine whether the entity is authorized to access the location information of the electronic device based on the determined access rights associated with the electronic device; decrypt the location information of the electronic device if the entity is authorized to access the location information based on the determined access rights; and provide the decrypted location information to the entity.

2. The system according to claim 1, wherein the server arrangement is configured to deny access to the location information of the electronic device if the entity is not authorized to access the location information based on the determined access rights.

3. The system according to claim 1, wherein the electronic device is configured to encrypt, and the server arrangement is configured to decrypt the location information using a public key and private key pair.

4. The system according to claim 1, wherein the server arrangement, the electronic device, and the entity are communicating over a blockchain network.

5. The system according to claim 1, wherein the electronic device is one of: a user device, an industrial asset, an IoT device, and an autonomous vehicle.

6. The system according to claim 1, wherein the entity is one of: an organization, a law enforcement agency, a health department, a government regulatory body, and an individual.

7. The system according to claim 1, wherein the electronic device is associated with an employee and the entity is an employer.

8. The system according to claim 7, wherein the server arrangement is configured to determine the access rights based on a contractual agreement between the employer and the employee.

9. The system according to claim 8, wherein the server arrangement is configured to determine the access rights based on time of services provided by the employee, location of services of the employee, and duration of services provided by the employee as agreed in the contractual agreement.

10. The system according to claim 8, wherein the server arrangement is configured to determine the access rights based on a state of an application installed in the electronic device, wherein the state of the application is one of: an active state and an inactive state.

11. The system according to claim 1, wherein the server arrangement is configured to determine the access rights based on emergency conditions in a geographical area of the electronic device, and wherein the emergency condition is one or more of: a natural calamity, an accident, an unauthorized access of the electronic device, and presence of the electronic device in a restricted geographical area.

12. The system according to claim 1, wherein the server arrangement is configured to determine the access rights based on a health condition of an individual associated with the electronic device.

13. The system according to claim 12, wherein the server arrangement is configured to provide the health condition of the individual to the entity, wherein the entity is at least one of: a health organization, a designated health specialist, and emergency contacts of the individual.

14. A method for securely providing location information of an electronic device, wherein the method comprises:
obtaining location information and associated permissions pertaining to the electronic device, the location information being encrypted by the electronic device;
determining access rights for the electronic device based on the permissions provided by the electronic device, wherein the access rights comprise one or more conditions for sharing location information;
receiving a request from an entity to access the location information of the electronic device;
determining whether the entity is authorized to access the location information of the electronic device based on the determined access rights associated with the electronic device; decrypting the location information of the electronic device if the entity is authorized to access the location information; and
providing the decrypted location information to the entity.

15. A computer-program product having machine-readable instructions stored therein, which when executed by the server arrangement, cause the server arrangement to perform a method according to claim 14.
